(19) United States
(12) Patent Application Publication
(10) Pub. No.: US 2001/0013080 A1
(43) Pub. Date: Aug. 9, 2001

(54) Multiprocessor system and transaction control method for the same

(76) Inventors: Shin Kameyama, Kodaira (JP); Hideya Akashi, Kunitachi (JP); Keitaro Uehara, Kokubunji (JP); Yuji Tsushima, Kokubunji (JP); Naoki Hamanaka, Tokyo (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/775,545

(22) Filed: Feb. 5, 2001

(30) Foreign Application Priority Data
Feb. 4, 2000 (JP) 2000-32738

(51) Int. Cl. G06F 12/00

(52) U.S. Cl. 710/200

(57) ABSTRACT

A multiprocessor system that performs processing of transactions issued consecutively by Posted Write with a device on an I/O bus as a transaction source or target. If one of a series of transactions with a device on some I/O bus of a plurality of I/O buses in the system as source is retried at a target node, the subsequent transactions from that I/O bus also are retried, and the sending unit of the source node reissues these transactions. At that time, a header flag is added to the first of a series of reissued transactions. At the transaction processing unit of the target node, if processing is impossible, a retry flag is set with the bit corresponding to the I/O bus of the issuing source in the retry flag register and a retry is returned to the source, and henceforth retries are returned also when receiving subsequent transactions with the same I/O bus as issuing source. When the resent transaction added the header flag is received, whether or not processing is possible is judged again. By this, assurance of the sequence of transaction processing is accomplished.

### BACKGROUND OF THE INVENTION

1. Technical Field of the Invention

The present invention relates to a multiprocessor system, or more generally, to a transaction control system, which assures the sequence of transactions with a device on an I/O bus as transaction source or transaction target.

2. Description of Related Art

As one method of processing write transactions issued by an I/O bus or processor bus on a system, there is Posted Write. Posted Write is a processing method by which a write transaction is completed on the source bus immediately after the system has received this transaction, and subsequent processing is performed under the responsibility of the system. When a write transaction is issued, it becomes possible for subsequent transactions to be issued from the bus or processor before that transaction is completed on the system, and the performance is improved.

However, by stipulation of PCI Bus Specifications Revision 2.1, and the like, there is a constraint that the sequence of write transactions with an I/O device on a PCI bus as transaction source must be assured.

### SUMMARY OF THE INVENTION

When transactions having a dependency relationship are issued consecutively and a preceding transaction is retried, if a subsequent transaction finishes first, the sequence is no longer assured. Here, retry means that when the transaction target is in a state in which access cannot be received temporarily, and the like, the transaction source is requested to again execute access a little while later. Accordingly, when some PCI bus issues a write transaction to the system side, that PCI bus will not issue subsequent transactions to the system side until its completion is assured without that write being retried, whereby this constraint is observed. As a result, there was a problem that when transactions having a dependency relationship are issued consecutively from a PCI bus, the throughput ends up being lowered

Likewise, in write transactions with a processor as the source and an I/O device on a PCI bus as the target, because there is a need to assure the sequence, there was a problem that because subsequent write transactions cannot be issued consecutively until the preceding write transaction is finished, the throughput ends up being lowered.

One object of the present invention is to provide a system by which high throughput is realized by consecutive issuing of transactions, and transaction processing with assured sequence is performed.

Another object of the present invention is to shorten the latency up to the end of each transaction.

According to a representative aspect of the present invention, there is the following structure in a multiprocessor system where a plurality of I/O units connected with each of at least one I/O bus connected with an I/O device, and a plurality of node controller units connected with each of at least one processor bus connected with a processor unit, are interconnected by a network.

First, in regard to the control of I/O-issued transactions to a processor bus connected with a node controller with an I/O bus as issuing source, each I/O unit as transaction source is provided with an I/O transaction sending unit that sequentially issues a series of I/O-issued transactions received from connected I/O buses, to target node controller units, regardless of the receipt of the acknowledgment of a preceding I/O-issued transaction from a target, and reissues an I/O-issued transaction which already has been issued when a retry for it is requested from a target. On the other hand, each node controller unit as target is provided with an I/O transaction processing unit, and each I/O transaction processing unit returns a retry request to a source I/O unit when an I/O-issued transaction is received and it is judged that processing is impossible, and automatically returns a retry request to the source I/O unit without executing processing in regard to a subsequent I/O-issued transaction with the same I/O bus as issuing source as the I/O bus being the issuing source of the transaction for which the retry request was returned.

Thus, by configuring a source unit such that subsequent transactions also are retried when one of a series of transactions with the same bus as issuing source is to be retried, the situation where a transaction issued later is received for processing at a target unit earlier than the preceding transaction and the processing sequence is reversed is prevented. That is, the sequence of a series of transactions is assured, there is no more need to adopt the method of issuing where a next transaction is issued after a source waits for the return of the acknowledgment of completion of a transaction from a target, and high-speed transactions become possible.

More substantially, a target unit, being each node controller unit in the above configuration, is provided with a retry flag register having an entry corresponding to each I/O bus being a transaction source, and each of those entries records a retry flag indicating the fact of retry request when a retry is requested for a transaction with the corresponding I/O bus as source. By utilizing this, if one of a series of transactions from the same I/O bus is retried, it is possible to retry also the subsequent transactions.

Cancellation of a retry at a target unit, that is, clearing of the corresponding retry flag, occurs when the first (transaction first retried and reissued) of a series of transactions reissued following a retry request is received and processing of it is possible at a target unit. Even if subsequent transactions of a series of reissued transactions are received, it is simply that retry is repeated automatically. For distinguishing between two states, that is, by judging whether the processing is possible, moving to transaction processing after cancelling the retries, if possible, or otherwise, repeating automatically a retry, the transaction sending unit of each I/O unit as source reissues adding a header flag to the first of a series of reissued transactions. In the configuration where a plurality of I/O buses is connected to one I/O unit, it may be made such that the header flag signifies also the first of a series of transactions with each I/O bus as issuing source. Furthermore, the transaction queue of each I/O unit is provided with a transaction attribute field for recording to distinguish whether it is a transaction issued for the first time or a reissued transaction.

An aspect of the present invention related to control of I/O-issued transactions to a processor bus connected to a node controller with I/O buses as issuing source was described above, but the completely identical configuration can be adopted also for processor-issued transactions to an I/O bus with processor buses as issuing source. That is, each node controller unit as transaction source is provided with a transaction sending unit that sequentially issues a series of transactions received from a processor bus, to a target I/O unit, and reissues a transaction which has already been issued when a retry for it is requested from a target. On the other hand, each I/O unit as target is provided with a processor transaction processing unit, and each processor transaction processing unit returns a retry request to a source node controller unit when it is judged that transaction processing is impossible, and automatically retries a subsequent transaction with the same processor bus as issuing source as the processor bus being the issuing source of the transaction for which the retry request was returned.

The substantial configuration, such as the point that each I/O unit as target is provided with a retry flag register, or the point that a header flag is added to the first of reissued transactions in issuing of transactions by each source node controller unit, also is the same as the configuration for control of I/O transactions described before.

Also possible is a source modification configured so that all of a series of transactions already sent are consecutively reissued in response to the return of a retry for one transaction from a target. In the case of this modification, there is no more need to return retries for subsequent transactions at the target, once having returned a retry for one transaction. However, regarding the subsequent transactions, even when they are received, processing for them is not performed. With such configuration, the communication overhead of returns becomes smaller, and higher-speed transaction processing becomes possible.

Also, in the above, the management unit of transactions is in the unit of a single processor bus, but it also may be in the unit of a single processor unit. In regard to I/O transactions, the final target of issued I/O transactions becomes each processor unit. Also, in regard to processor transactions, each processor transaction processing unit is configured so as to automatically retry a subsequent transaction with the same processor unit as issuing source as the processor unit being the issuing source of the transaction for which a retry request was returned. The retry flag register of each I/O unit is configured to have a retry flag set in the unit of a processor unit being issuing source.

It is possible also to adopt the configuration such that a header flag is encoded in a transaction instead of adding a header to a transaction in order to distinguish a leading transaction.

The other characteristics of the present invention will become clear by the description of preferred embodiments.

### BRIEF DESCRIPTION OF THE DRAWINGS

FIG. 1 is a diagram for showing the configuration of a multiprocessor system realizing the present invention

FIG. 2 is a diagram for showing the format of a transaction issued from I/O transaction sending unit 120.

FIG. 3 is a diagram for explaining the method by which I/O unit 11 issues an I/O transaction.

FIG. 4 is a diagram for explaining the operation when node controller unit 21 receives an I/O transaction

FIG. 5 is a diagram for explaining the operation when node controller unit 21 retries an I/O transaction

FIG. 6 is a diagram for explaining the operation when I/O unit 11 reissues an I/O transaction for which retry was requested.

FIG. 7 is a diagram for explaining the operation when node controller unit 21 processes a reissued I/O transaction

FIG. 8 is a diagram for explaining the method by which node controller unit 21 issues a processor transaction

FIG. 9 is a diagram for explaining the operation when I/O unit 11 receives a processor transaction

FIG. 10 is a diagram for explaining the operation when I/O unit 11 retries a processor transaction

FIG. 11 is a diagram for explaining the operation when node controller unit 21 reissues a processor transaction for which retry was requested.

FIG. 12 is a diagram for explaining the operation when I/O unit 11 processes a reissued processor transaction

### DESCRIPTION OF THE PREFERRED EMBODIMENTS

Below, preferred embodiments of the present invention are explained, referring to the drawings, with an example of an I/O-issued memory write as a transaction with a device on an I/O bus as source, and also an example of a processor bus-issued I/O write as a transaction with a device on an I/O bus as target. In the following explanation, I/O-issued transactions are noted as I/O transactions, also processor bus-issued transactions are noted as processor transactions. Also, when a series of transactions is noted, it signifies transactions in a dependency relationship, more specifically, a group of consecutive transactions with a single bus (I/O bus or processor bus) as issuing source.

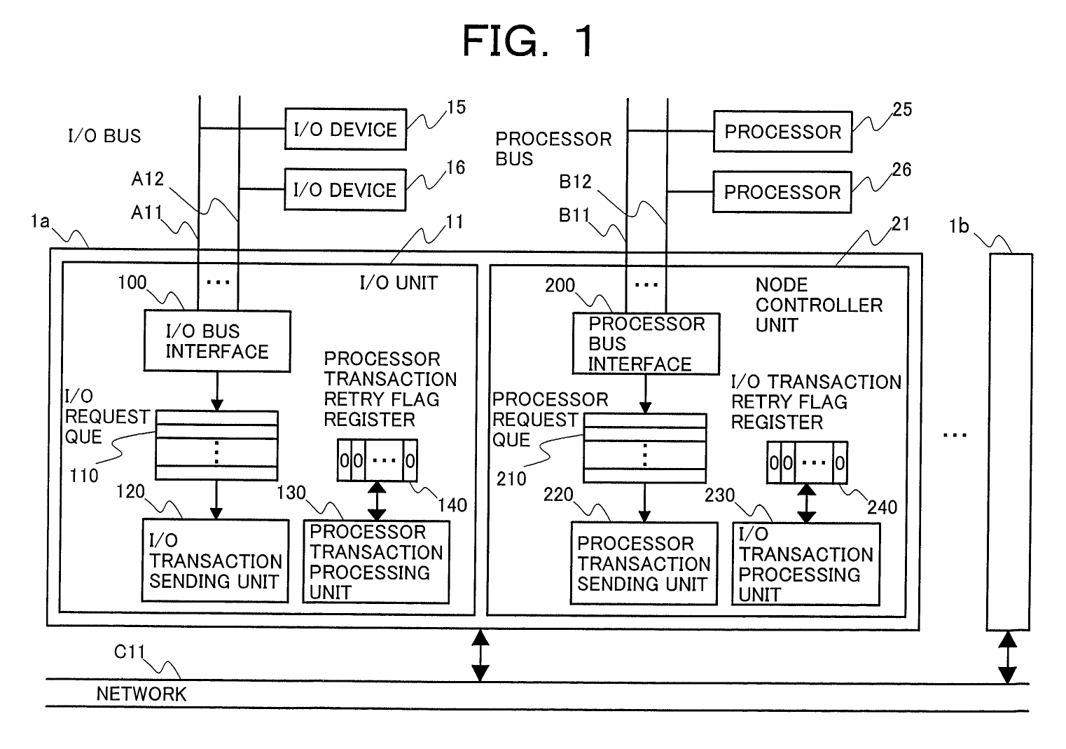

FIG. 1 is a schematic drawing showing the configuration of a multiprocessor system pertaining to one preferred embodiment of the present invention In FIG. 1, I/O unit 11 included in node 1a is connected with a plurality of I/O buses A11 and A12, and a plurality of I/O devices 15 and 16 are connected via these. Also, in the drawing, one I/O device each is connected respectively to each I/O bus, but a configuration where a plurality of I/O devices is connected to each I/O bus also is possible. On the other hand, node controller unit 21 is connected with a plurality of processor buses B11 and B12, and a plurality of processor units 25 and 26 can be connected via these. Here too, a configuration where a plurality of processor units is connected to each processor bus also is possible. I/O unit 11 performs control of a transaction issued from a device on an I/O bus or a transaction issued to a device on an I/O bus. Also, node controller unit 21 performs control of a transaction issued from a processor unit on a processor bus or a transaction issued to a processor unit on a processor bus. As shown with node 1b, nodes of the same configuration as mentioned above are provided multiply and redundantly. Those nodes are connected by network C11, thereby constituting a multiprocessor system. Also, a multiprocessor system where nodes having only one of either an I/O unit or node controller unit are mixed with the illustrated nodes having both also is possible. Also, a multiprocessor system also can be configured with nodes with an I/O unit only and units of a node controller only. Network C11 has an internal buffer not illustrated and performs buffering of transactions issued from each node. Therefore, consecutive issuing of transactions from each node is possible.

I/O unit 11 has I/O bus interface 100 with a plurality of I/O buses A11-A12, I/O request queue 110 which stores transactions from I/O buses A11-A12, I/O transaction sending unit 120 which has the function of sequentially issuing transactions stored in the I/O request queue without waiting for completion of preceding transactions, processor transaction processing unit 130 which processes processor transactions, and processor transaction retry flag register 140. Here processor transaction retry flag register 140 has entries with initial value ‘0’ called retry bit corresponding individually to all the processor buses in the multiprocessor system, and records from which processor bus retry was requested for a transaction.

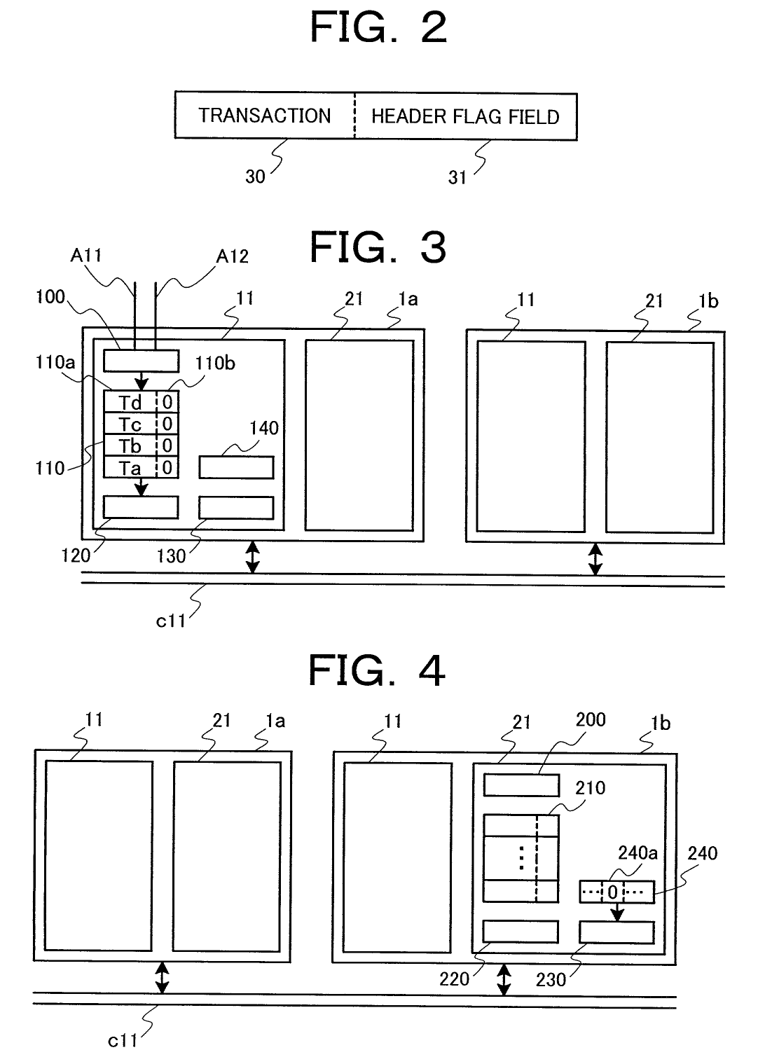

Here, the format of a transaction issued from I/O transaction sending unit 120, as shown in FIG. 2, consists of field 30 showing a transaction itself such as source bus ID, target bus ID and request contents, and header flag field 31. Header flag field 31 is set to “1” for the leading transaction and “0” for subsequent transactions of a series of consecutive transactions from a device connected to a single I/O bus in sequentially issued transactions. Also, as is described in detail later, in the present preferred embodiment, when a retry arises at a target before transfer of a series of transactions from a single bus is complete, not only the transaction first retried, but also the subsequent transactions in the series of transactions are retried, and those transactions come to be reissued. The header flag field value assigned to the first transaction of that reissue also is “1”. I/O transaction sending unit 120 thus has the function of adding the header flag distinguishing whether or not it is the first of a series of transactions.

Node controller unit 21 has processor bus interface 200 with a plurality of processor buses B11-B12, processor request queue 210 which stores transactions from processor buses B11-B12, processor transaction sending unit 220 which has the function of sequentially issuing transactions stored in processor request queue 210 without waiting for completion of preceding transactions, I/O transaction processing unit 230 which processes I/O transactions, and I/O transaction retry flag register 240. Here, transactions issued from processor transaction sending unit 220 also have the same format as in FIG. 2. That is, processor transaction sending unit 220 issues or reissues processor transactions, adding a header flag which distinguishes whether or not it is the first of a series of processor transactions from a single processor bus. I/O transaction retry flag register 240 has entries with initial value ‘0’ called retry bit corresponding individually to all the I/O buses in the multiprocessor system, and records from which I/O bus a transaction was retried.

Below, the method of assuring the sequence in consecutive issuing of a series of transactions Ta-Td is described with an example of the case when a retry has occurred with Tc.

First, assurance of the sequence of I/O transactions is explained using FIG. 3-FIG. 7.

FIG. 3 shows the state when a series of transactions Ta-Td was issued from a device on I/O bus A11 to node 1a. Each entry in I/O request queue 110 is constituted by transaction field 110a and transaction attribute field 110b, and issued transactions are stored in sequence in transaction field 110a. In transaction attribute field 110b, there is recorded the fact that each transaction is a transaction requested for the first time, that is, the fact that it is not a transaction that is about to be reissued because it was once issued to a target node but retry was requested because processing was not possible at the target. In this example, substantially ‘0’ is set.

I/O transaction sending unit 120 issues a transaction to target node 1b via network C11. At this time, a value of header flag field 31 assigned by I/O transaction sending unit 120 is “1” for leading transaction Ta and “0” for subsequent transactions. Also, if a series of transactions from a separate I/O bus, for example, such as I/O bus A12, is input following transaction Td, when the first of the series of transactions from that separate I/O bus is issued from I/O transaction sending unit 120, that header flag field is set to “1”.

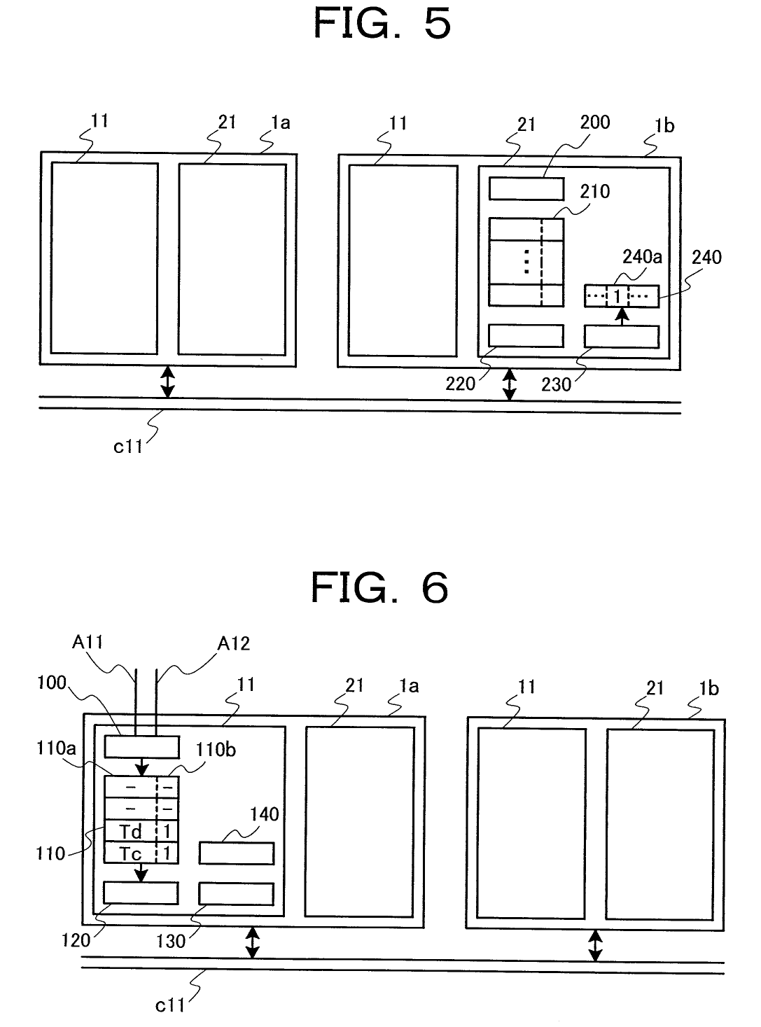

The behavior during receipt of a transaction is described with FIG. 4-FIG. 5.

First, the algorithm in the transaction processing unit of a target node is as follows.

(1) If the bit corresponding to a received transaction in the retry flag register is “0”, it is judged as to whether or not execution of transaction processing is possible, and if possible, an acknowledgment of OK is returned to the source and processing is executed. If not possible, a retry is requested to the source, and “1” is recorded for the corresponding bit in the retry flag register.

(2) If the bit corresponding to the received transaction in the retry flag register is “1” and the header flag of the received transaction is “1”, it is judged as to whether or not execution of transaction processing is possible. If execution is possible, an acknowledgment of OK is returned to the source and transaction processing is executed, and the corresponding bit in the retry flag register is cleared to “0”. If execution is not possible, a retry request is returned to the source.

(3) If the bit corresponding to the received transaction in the retry flag register is “1” and the header flag of the received transaction is “0”, transaction processing is not executed, and a retry request is automatically returned to the source.

In FIG. 4, when I/O transaction processing unit 230 of target node 1b receives transaction Ta, it is known that Ta is the first of a series of transactions from the fact that a header flag is added. Furthermore, as shown in FIG. 4, it is known that the transactions from the I/O bus being the issuing source of Ta are not being retried from the fact that retry bit 240a in I/O transaction retry flag register 240 corresponding to I/O bus A11 which issued Ta is ‘0’. As a result, I/O transaction processing unit 230 judges whether transaction processing is possible. Here, because execution is possible, transaction processing is executed for Ta, and OK is returned to node 1a.

Next, when I/O transaction processing unit 230 receives transaction Th, here too, because the corresponding retry bit 240a in I/O transaction retry flag register 240 is ‘0’ and a header flag has not been added to Th (the value in the header flag field is “0”), it is judged as to whether execution of processing is possible, and because execution is possible, ordinary processing is performed for Th, and OK is returned to node 1a.

When I/O transaction processing unit 230 receives Tc, here too, because the corresponding retry bit 240a in I/O transaction retry flag register 240 is “0”, judgment as to whether execution is possible is performed. However, here it is judged that processing of Tc cannot be performed for some reason, and I/O transaction processing unit 230 requests a retry to source node 1a. At this time, as shown in FIG. 5, retry bit 240a corresponding to I/O bus A11 in I/O transaction retry flag register 240 is set to ‘1’. That is, the fact that retry was requested for the transactions with I/O bus A11 as source is recorded.

Next, I/O transaction processing unit 230 receives Td. Because the corresponding retry bit 240a in I/O transaction retry flag register 240 is ‘1’ and a header flag has not been added to the received Td, I/O transaction processing unit 230 requests a retry for the received transaction That is, I/O transaction processing unit 230 requests a retry for transaction Td regardless as to whether or not processing is possible.

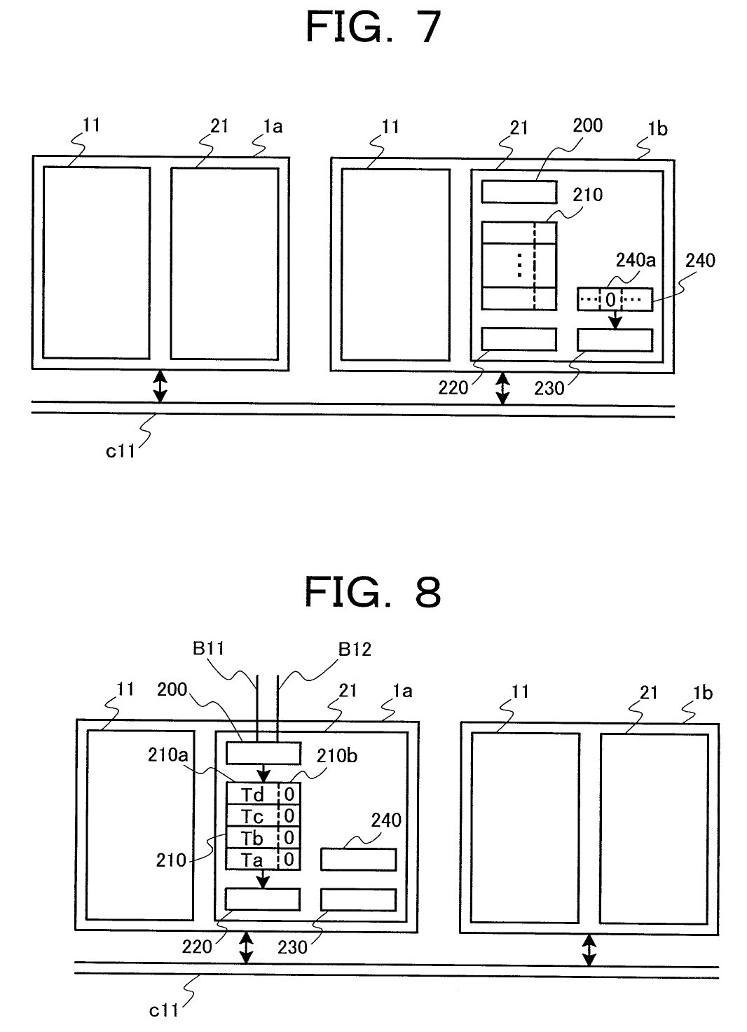

The behavior when a retry occurs is described with FIG. 6-FIG. 7.

First, the algorithm for issuing of a transaction of I/O transaction sending unit 120 is described.

(1) Basically, transaction requests from an I/O bus being accumulated in I/O request queue 110 are issued as I/O transactions in the sequence of the queue (sequential issuing without waiting for acknowledgment).

(2) When an acknowledgment of OK is returned from a target, the transaction corresponding to that is deleted from the queue.

(3) When a request for retry is returned from a target, the sequential issuing in (1) above is halted, ‘1’ is set to transaction attribute field 110b for the corresponding transactions remaining in I/O request queue 110, and they are reissued.

(4) In the issuing above, a header flag is added to the first of a series of I/O transactions from the same I/O bus. Also in the case of the reissuing in (3) above, if it is not subsequent to a previous reissuing but is the first of a reissuing, a header flag is added in the same manner.

(5) When an acknowledgment of OK is returned from the target in the reissuing state, it returns to the sequential issuing in (1) above.

Returning to the example in the drawing and continuing the explanation, at node 1a, because OK has been returned from node 1b regarding Ta and Th, the entries for Ta and Tb are deleted from I/O request queue 110. However, because a retry request was received from node 1b regarding Tc and Td, as shown in FIG. 6, ‘1’s indicating that they are transactions for which retries were requested are set in transaction attribute field 110b. I/O transaction sending unit 120 resends the transactions according to the retry request. At this time, because transaction Tc becomes the leading transaction, it is reissued adding header flag 31.

At node 1b, because the header is added to the received Tc and the corresponding retry bit 240a in I/O transaction retry flag register 240 is ‘1’ as shown in FIG. 5, it is known that Tc is the first of the reissued transactions. At this time, I/O transaction processing unit 230 confirms whether transaction processing is possible, and if possible, as shown in FIG. 7, I/O transaction processing unit 230 clears the corresponding retry bit 240a in I/O transaction retry flag register 240 to ‘0’, and executes processing for Tc. If the retry bit becomes ‘0’, processing in I/O transaction processing unit 230 becomes the same as at first, and processing is executed through judgment that processing can be done for Td too.

Also, when the first of the reissued transactions Tc is received, if it is judged that processing is not still possible at I/O transaction processing unit 230, retry is requested again for Tc. Thus, because the retry flag is ‘1’, retry is requested for the subsequent Td as well. Judgment as to whether processing is possible is performed, and that is, the chance for the retry state to be cancelled is only when the first (Tc) of the series of transactions (Tc, Td) being reissued is received.

As above, in regard to a series of I/O transactions with a device on one I/O bus as issuing source, when a retry request is once returned from a target node, a retry request comes to be returned for the subsequent transactions as well. Accordingly, I/O transactions that are not processed all come to be reissued. Also, the handling at a target (processing or otherwise retrying) of transactions left behind as reissue at a source is not changed on the way. Accordingly, for a series of I/O transactions from a single I/O bus, the sequence is always assured regardless of the timing when the state of a target node has become capable of processing.

Next, assurance of the sequence of processor transactions is explained using FIG. 8-FIG. 12. The processing algorithm of processor transaction sending unit 220 pertaining to the issuing of processor transactions is the same as the processing algorithm of I/O transaction sending unit 120 pertaining to the issuing of I/O transactions, which was described above. Also, the processing algorithm of processor transaction processing unit 130 being the target of processor transactions also is the same as the processing algorithm of the I/O transaction processing unit pertaining to processing of I/O transactions.

Describing in sequence, FIG. 8 shows the state when transactions Ta-Td were issued from some processor unit to node 1a. Each entry of processor request queue 210 also is constituted by transaction field 210a and transaction attribute field 210b, and issued transactions are sequentially stored in transaction field 210a. In transaction attribute field 210b, ‘0’s are set because each transaction is a transaction requested for the first time.

Next, processor transaction sending unit 220 issues transactions to target node 1b via network C11. Here too, a header flag field as shown in FIG. 2 is added to each transaction in the same manner as with I/O transactions. Because Ta is the first of a series of transactions, processor transaction sending unit 220 sets ‘1’ in the header flag field. ‘0’ is set in the header fields of the subsequent transactions.

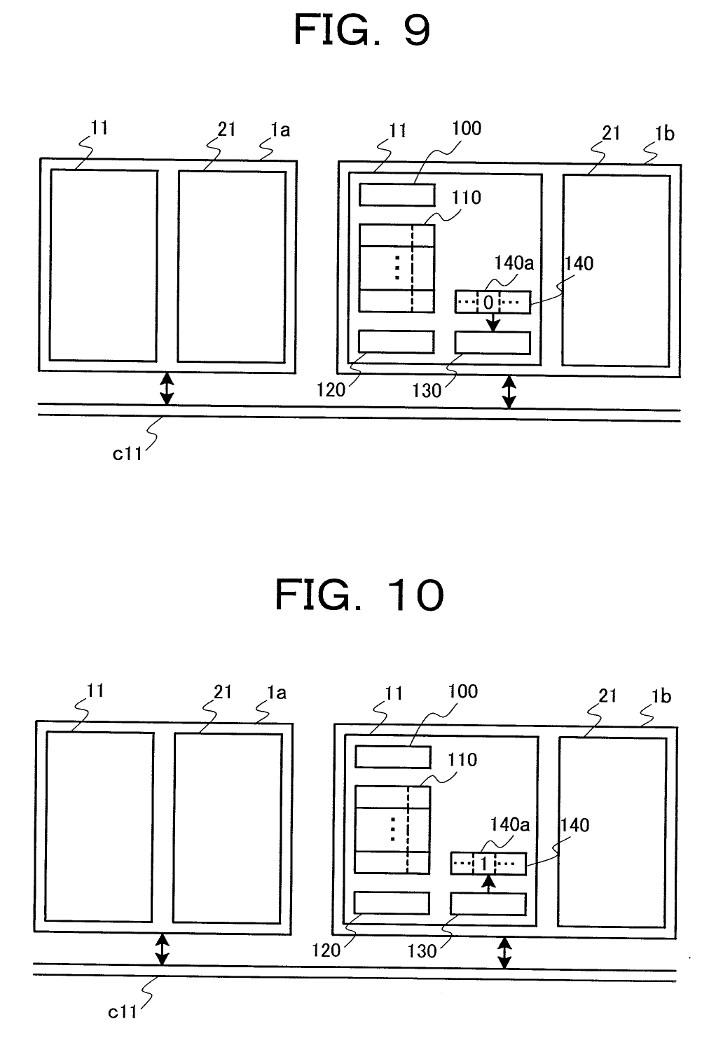

The behavior during receipt of a transaction is described with FIG. 9-FIG. 10.

At target node 1b, the transactions received in processor transaction processing unit 130 are sequentially processed. When processor transaction processing unit 130 receives transaction Ta, as shown in FIG. 9, because the corresponding retry bit 140a in processor transaction retry flag register 140 corresponding to the processor bus which issued Ta is ‘0’, it is known that Ta is a transaction that was issued for the first time. As a result, processor transaction processing unit 130 judges whether processing of Ta is possible, and here, because processing is possible, the transaction processing is executed, and OK is returned to node 1a.

Next, when processor transaction processing unit 130 receives transaction Tb, here too, because the corresponding retry bit 140a is ‘0’, judgment of whether processing is possible is performed. Because processing is possible, ordinary processing is performed for Th, and OK is returned to node 1a.

When processor transaction processing unit 130 receives Tc, because the corresponding retry bit 140a is ‘0’, judgment of whether processing is possible is performed, but here, because processing of Tc cannot be performed for some reason, processor transaction processing unit 130 requests a retry to the source node 1a. At this time, as shown in FIG. 10, the corresponding retry bit 140a in processor transaction retry flag register 140 is set to ‘1’. Next, when processor transaction processing unit 130 receives Td, because the corresponding retry bit 140a in processing transaction processing unit 130 is ‘1’ and a header flag has not been added to Tc, processor transaction processing unit 130 requests a retry for Td as well.

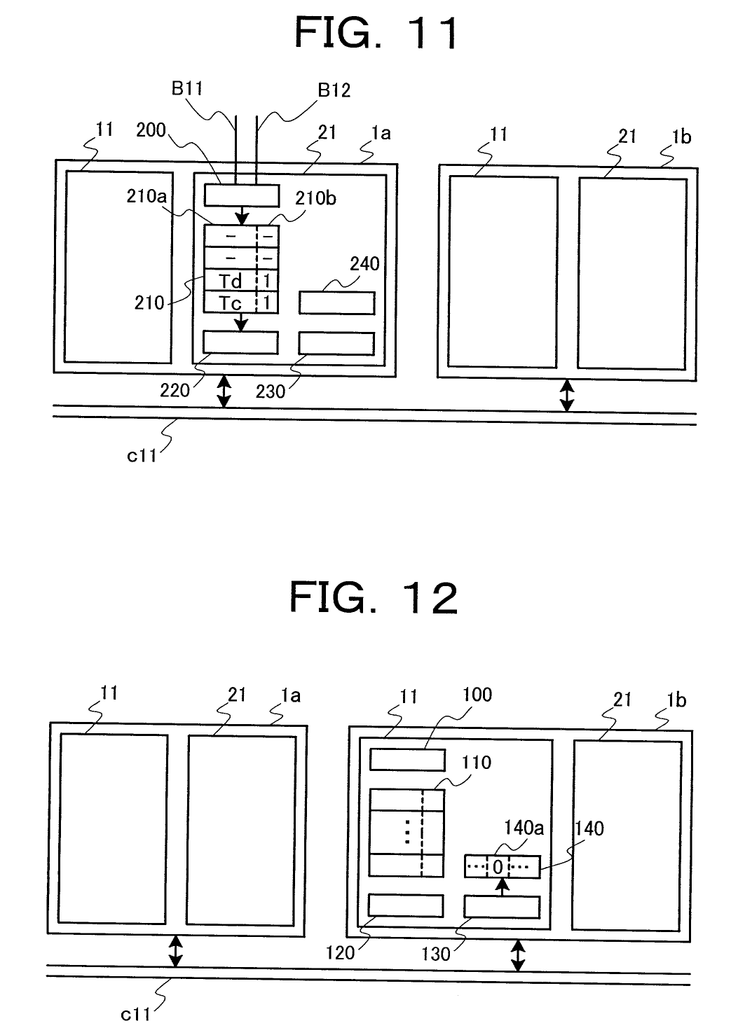

The behavior when a retry occurs is described with FIG. 11-FIG. 12. At node 1a, because OK was returned from node 1b regarding Ta and Th, the entries for Ta and Th are deleted from processor request queue 210. However, because a retry request was received from node 1b regarding Tc and Td, as shown in FIG. 11, in transaction attribute field 210b, ‘1’ being the value indicating the fact that they are transactions for which retry was requested is set. Processor transaction sending unit 220 resends the transactions according to the retry request. At this time, because transaction Tc is the leading transaction, it is reissued adding a header flag.

At node 1b, because the header flag has been added to the received Tc and the corresponding retry bit 140a in processor transaction retry flag register 140 is ‘1’ as shown in FIG. 10, it is known that Tc is the first of the reissued transactions. As a result, it is judged as to whether transaction processing is possible, and because processing is possible here, as shown in FIG. 12, processor transaction processing unit 130 clears the corresponding retry bit 140a in processor transaction retry flag register 140 to ‘0’, and executes processing for Tc. Next, when Td is received, because the corresponding retry bit 140a already is ‘0’, processing for Td is performed with the same handling as the previous Ta and Th.

By the above processing, even when a transaction from some processor bus is retried, the subsequent transactions also can be retried in the same manner as with retrying of I/O transactions, and the sequence of transactions is assured.

In the preferred embodiment described above, when a request for retry is returned for one of a series of transactions, the source reissues the corresponding transaction, and henceforth the source becomes in a special reissuing mode. That is, it is not the operation of sequential issuing regardless of acknowledgment, and it becomes the operation of waiting for a next retry request and reissuing the next. Instead of this, it is possible also to adopt a configuration such that when a retry request is returned for one of a series of transactions, a series of reissues of transactions to be reissued with the same bus as issuing source is performed sequentially without waiting for the individual responses. The algorithm of the transaction sending unit of a source in this modified example is as follows.

(1) The transactions from a bus being accumulated in the request queue are issued in the sequence of the queue.

(2) When an acknowledgment of OK is received from the target, the transaction corresponding to that is deleted from the queue. (The above is the same as in the above-mentioned preferred embodiment.)

(3) When a request for retry is returned from the target, ‘1’ is set to the transaction attribute fields not only for the corresponding transaction, but for all of the series of transactions with the same bus as issuing source, which are remaining in the request queue and have been already issued. And the series of transactions where the attribute field is ‘1’ is consecutively reissued in sequence from the first one (the one corresponding to the retry request).

(4) In the issuing above, a header flag is added to the first of the series of transactions from the same bus. In the case of the reissuing in (3) above as well, a header flag is added in the same manner, not to the successors following a previous reissuing, but to the first of a reissuing. (The above is also the same as in the above-mentioned preferred embodiment.)

(5) When an acknowledgment of OK is returned from the target in the reissuing state, the corresponding transaction is deleted from the request queue, and at the same time, the transaction attribute fields of the transactions from the same bus following that are reset from ‘1’ to ‘0’.

In the above modified example, the transactions subsequent to the retried transaction are automatically reissued from the source. Accordingly, there is no need to return a retry request from the target to the source for each of those subsequent transactions, and even when those subsequent transactions are received, if transaction processing is not performed, there is no problem The processing algorithm of the transaction processing unit as target is as follows.

(1) If the bit corresponding to a received transaction in the retry flag register is “0”, it is judged as to whether or not execution of the transaction processing is possible, and if possible, an acknowledgment of OK is returned to the source, and the processing is executed. If not possible, a retry is requested to the source, and “1” is recorded for the corresponding bit in the retry flag register. (This point is the same as in the initial preferred embodiment.)

(2) If the bit corresponding to the received transaction in the retry flag register is “1” and the header flag of the received transaction is “1”, that is, when the first of a series of reissued transactions is received, or the first of transactions with a separate bus as issuing source after a series of reissuing is received, it is judged as to whether or not execution of the processing is possible. If execution is possible, an acknowledgment of OK is returned to the source and the transaction processing is executed, and the corresponding bit in the retry flag register is cleared to “0”. If execution is not possible, a retry request is returned to the source.

(3) If the bit corresponding to the received transaction in the retry flag register is “1” and the header flag of the received transaction is “0”, judgment as to whether or not execution of the transaction processing is possible is not performed, and the transaction processing also is not performed.

In the modified example as above, even when a series of reissuing is finished, it may be the case that an acknowledgment of OK or a request for retry regarding the first of the reissuing does not return At this time, if transactions from the same bus have been further accumulated following this reissued transaction in the request queue, those also may continue to be issued. Also, if a separate series of transactions with a separate bus as issuing source has been accumulated, issuing is performed, adding a header flag to the first of them by (4) of the above request-side algorithm In either case, if a retry is again requested afterwards regarding the first of the reissued transactions, at that time, because all of the already reissued transactions from the same bus are reissued by (3) of the above request-side algorithm, the processing sequence is assured.

As above, even in the modified example made so that reissuing after retrying is successively issued, assurance of the sequence of processing becomes possible for a series of transactions from the same bus. In the transaction sending unit on the requesting side, the amount of hardware for managing the transaction attribute field in the request queue becomes greater than in the previous preferred embodiment, but because the overhead of the responses from the target is small and successive issuing regardless of the responses from the target is possible even with a series of reissuing, higher-speed transaction processing can be realized.

Also, in the above preferred embodiment, the management unit of transactions was in the unit of each I/O bus and the unit of processor bus. Instead of this, a configuration such that the management unit is in the unit of each I/O device and the unit of processor unit also is possible. Describing about the configuration which is changed from the unit of processor bus to the unit of processor unit, it becomes as follows. First, at node controller unit 21 in FIG. 1, each processor unit 25, 26 is recognized as issuing source regarding processor transactions to receive. In retry flag register 140 of each I/O unit being a target of processor transactions, entries corresponding to individual processor units are provided. In processor transaction processing unit 130 of a target I/O unit, if a processor transaction with some processor unit as issuing source is retried, a retry flag is recorded in the entry corresponding to that processor unit, and using this, the subsequent processor transactions with the same processor unit as issuing source also are retried.

Also, in the multiprocessor system of the preferred embodiment, the node of a transaction target performs the retry control, but as a modified example of the preferred embodiment, in the case where all nodes snoop coherently controlled transactions, it is possible for any node to perform the retry control.

What is claimed is:

1. A multiprocessor system, comprising:
a plurality of I/O units connected with each of at least one I/O bus connected with an I/O device;
a plurality of node controller units connected with each of at least one processor bus connected with a processor unit; and
a network interconnecting the above plurality of I/O units and the above plurality of node controller units,
wherein:
each I/O unit is provided with an I/O transaction sending unit that sequentially issues a series of I/O-issued transactions received from a connected I/O bus, to a target node controller unit, regardless of the receipt of an acknowledgment of a preceding I/O-issued transaction from the target, and also reissues an I/O-issued transaction which has been already issued when a retry for it is requested from the target;
each node controller unit is provided with an I/O transaction processing unit that performs transaction processing when the target of an issued I/O-issued transaction is a processor bus connected to its own unit; and
each I/O transaction processing unit returns a retry request to a source I/O unit when an I/O-issued transaction is received and it is judged that processing is impossible, and also returns a retry request to the source I/O unit without executing processing in regard to a subsequent I/O-issued transaction with the same I/O bus as issuing source as the I/O bus being the issuing source of the transaction for which the retry request was returned.

2. A multiprocessor system, comprising:
a plurality of I/O units connected with each of at least one I/O bus connected with an I/O device;
a plurality of node controller units connected with each of at least one processor bus connected with a processor unit; and
a network interconnecting the above plurality of I/O units and the above plurality of node controller units,
wherein:
each said node controller unit is provided with a processor transaction sending unit that sequentially issues a series of processor-issued transactions received from a connected processor bus, to a target I/O unit, regardless of the receipt of an acknowledgment of a preceding processor-issued transaction from the target, and also reissues a processor transaction which has been already issued when a retry for it is requested from the target;
each said I/O unit is provided with a processor transaction processing unit that performs transaction processing when the target of an issued processor-issued transaction is an I/O bus connected to its own unit; and
each processor transaction processing unit returns a retry request to a source node controller unit when a processor-issued transaction is received and it is judged that processing is impossible, and also returns a retry request to the source processor bus without executing processing in regard to a subsequent processor-issued transaction with the same processor bus as issuing source as the processor bus being the issuing source of the transaction for which the retry request was returned.

3. A multiprocessor system, comprising:
a plurality of I/O units connected with each of at least one I/O bus connected with an I/O device;
a plurality of node controller units connected with each of at least one processor unit; and
a network interconnecting the above plurality of I/O units and the above plurality of node controller units,
wherein:
each said node controller unit is provided with a processor transaction sending unit that sequentially issues a series of processor-issued transactions received from a connected processor unit, to a target I/O unit, regardless of the receipt of an acknowledgment of a preceding processor transaction from the target, and also reissues a processor-issued transaction which has been already issued when a retry for it is requested from the target;
each said I/O unit is provided with a processor transaction processing unit that performs transaction processing when the target of an issued processor-issued transaction is an I/O bus connected to its own unit; and
each processor transaction processing unit returns a retry request to a source node controller unit when a processor-issued transaction is received and it is judged that processing is impossible, and also returns a retry request to the source processor unit without executing processing in regard to a subsequent processor-issued transaction with the same processor unit as issuing source as the processor unit being the issuing source of the transaction for which the retry request was returned.

4. A transaction control method for a multiprocessor system having a plurality of I/O units where each I/O unit has an interface with at least one I/O bus connected with an I/O device, and a plurality of node controller units where each node controller unit has an interface with at least one processor bus connected with a processor unit, which are interconnected with a network; and the function of issuing a transaction with any of said plurality of node controller units or said plurality of I/O units as a source unit and another unit as target, wherein:
when the unit as target returns a retry request to the source unit regarding one transaction, said target unit also returns a retry request for a subsequent transaction where the same bus as the issuing source of said one transaction is the issuing source; and
said source unit reissues the transactions for which retry was requested.

5. A transaction control method of the multiprocessor system recited in claim 4, wherein:
said target unit, after once having returned a retry request, again determines whether to request retry or execute processing by judging whether or not processing is possible, only in the case where a received transaction is the first of reissued transactions.

6. A transaction control method for a multiprocessor system having a plurality of I/O units where each I/O unit has an interface with at least one I/O bus connected with an I/O device, and a plurality of node controller units where each node controller unit has an interface with at least one processor bus connected with a processor unit, which are interconnected with a network; and the function of issuing a transaction with any of said plurality of node controller units or said plurality of I/O units as a source unit and another unit as target, wherein:
said source unit, when receiving a retry request regarding one transaction of a series of transactions from one bus, sequentially reissues said one transaction and all of the transactions which have been already issued where the same bus as the issuing source of said one transaction is the issuing source; and
said unit as target, when judging that processing is not possible for one transaction and returning a retry, does not execute processing even when a subsequent transaction where the same bus as the issuing source of said one transaction is the issuing source, is received.

7. A transaction control system, comprising:
a plurality of first units where a plurality of first buses connected with a device as an access source are connected individually or in groups of a multiple;
a plurality of second units where a plurality of second buses connected with a device as an access target are connected individually or in groups of a multiple; and
a network interconnecting said plurality of first units and said plurality of second units;
wherein:
each of said first units has a transaction sending means that sequentially issues a series of transactions with a connected first bus as issuing source, to a target, regardless of the receipt of an acknowledgment of a preceding transaction from the target, and also reissues a transaction which has been already issued when a retry for it is requested from said second unit as target; and
each of said second units has a transaction processing means that returns a retry request to said first unit as source when it receives said issued transaction as target and processing is impossible, and also returns a retry request to said first unit being said source, also for a subsequent transaction with said first bus being the same as said first bus being the issuing source of the transaction for which the retry request was returned, as issuing source.

8. The transaction control system recited in claim 7, wherein:
each of said second units has a register having entries corresponding to the number of said first buses, and in each entry, there is recorded a retry flag indicating that retry was requested for a transaction with a corresponding said first bus as issuing source.

9. The transaction control system recited in claim 8, wherein:
the retry flag of each entry of said register is cleared when the first of those reissued among the transactions with a corresponding said first bus as issuing source is received and it is judged that transaction processing is possible at said second unit.

10. The transaction control system recited in claim 9, wherein:
said transaction processing means, when receiving a subsequent transaction with a corresponding said first bus as issuing source during the period when said retry flag is being recorded, returns a retry request to said first unit being the source, also for said subsequent transaction.

11. The transaction control system recited in claim 7, wherein:
said transaction sending means reissues adding a header flag to the leading transaction of a series of reissued transactions.

12. The transaction control system recited in claim 7, wherein:
each of said first units has a transaction queue sequentially storing transactions input from a connected first bus; and
said transaction queue has a transaction attribute field which stores the information that distinguishes whether a transaction is a transaction that is issued for the first time from said unit or a transaction that is reissued by a retry request.

13. The transaction control system recited in claim 7, wherein:
each of said first units has a transaction queue sequentially storing transactions input from a connected first bus;
said transaction queue has a transaction attribute field which stores the information that distinguishes whether a transaction is a transaction that is issued for the first time from said unit or a transaction that is reissued by a retry request; and
said transaction sending means identifies the transaction being the first of those reissued among a series of transactions from the same first bus from the value of said transaction queue attribute field, and adds a header flag when it is issued.

14. A transaction control system, comprising:
a plurality of first units where a plurality of first buses connected with a device as an access source are connected individually or in groups of a multiple;
a plurality of second units where a plurality of second buses connected with a device as an access target are connected individually or in groups of a multiple; and
a network interconnecting said plurality of first units and said plurality of second units;
wherein:
each of said first units has a transaction sending means that sequentially issues a series of transactions with a connected first bus as issuing source, to a target, regardless of the receipt of an acknowledgment of a preceding transaction from the target, and when a retry is requested from said second unit being the target regarding one transaction, sequentially reissues all of the transactions which have been already issued subsequent to said one transaction among said series of transactions; and
each of said second units has a transaction processing means that, when it receives an issued transaction as target, judges whether or not processing is possible, returns a retry request to said first unit being the source when processing is impossible, and also does not perform execution of processing even when a subsequent transaction with said first bus being the same as said first bus being the issuing source of the transaction for which a retry request was returned, as issuing source, is received.
